(19) United States
(12) Patent Application Publication
(10) Pub. No.: US 2008/0235113 A1
(43) Pub. Date: Sep. 25, 2008

(54) ENHANCED CONTROL OF ON-LINE AUCTION

(76) Inventors: Nancy J. Rabenold, Brandon, FL (US); James A. Simmons, Brandon, FL (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/053,047

(22) Filed: Mar. 21, 2008

Related U.S. Application Data
(63) Continuation-in-part of application No. 10/913,886, filed on Aug. 6, 2004.
Application No. 10/913,886 is a continuation of application No. 09/866,191, filed on May 25, 2001, now Pat. No. 6,813,612.
(60) Provisional application No. 60/207,030, filed on May 25, 2000.

(51) Int. Cl. G06F 17/30

(52) U.S. Cl. 705/27

(57) ABSTRACT

An online auctioning system that includes functions and features to help apply psychological tactics to increase sells, bidding activity and bid levels. The auctioning system allows and administrator to view items available for the auction, group them in a manner that may give the appearance of scarcity and/or may improve the relative worth of the items. One aspect of the invention is to provide a bidding/sell agnostic credit rating system that enables participants to qualify for a certain number of credits during the auction independent of what the particular items actually sell for during the auction. Each item in the auction may include a credit value and the credit values may also be used in grouping items to further create the appearance of scarcity and/or relative worth.

### CROSS-REFERENCE TO RELATED APPLICATIONS

This application is a continuation-in-part of co-pending United States application for patent which was filed on Aug. 6, 2004 with a title of INTEGRATED ON-LINE AND ON-SITE AUCTIONING SYSTEM INCLUDING AUDIO AND/OR VIDEO CAPABILITIES and was assigned Ser. No. 10/913,886, which application is a continuation of United States application for patent which was filed on May 25, 2001 and assigned Ser. No. 09/866,191 now issued as U.S. Pat. No. 6,813,612, which application claims the benefit of the filing date of U.S. Provisional Application for patent filed on May 25, 2000 and assigned Ser. No. 60/207,030, each such applications are hereby incorporated by reference.

### BACKGROUND OF THE INVENTION

One may conjecture that successful sells, or successful marketing activity for a product or service is more psychology than physiology. What this means is that a company that employs smart moves from a psychological perspective but has an inferior product, may actually outsell a company with a superior product that does not leverage the physiological maneuvers that are employed by others. At a minimum, there is significant weight given to the psychological aspects.

Although the concept of actually using mind control to promote sells may sound offensive, it is actually employed more frequently than we realize. For instance, why in the world would a poster of a pretty lady in a cowboy hat be used to advertise COPENHAGEN snuff? Are we to believe that she uses such a substance? Are we to believe that her boy friend actually walks around with a pinch between his cheek and gum? No, it is pretty evident that the poster makes you look, and looking gets you to buy. That is mind control.

As Kevin Wilke and Matt Gill, co-founders of Nitromarketing.com state in their article entitled “How to Control the Mind of Your Prospects—And Influence Them to Buy What You're Selling”, mind control, as used ethically in sales and marketing, is simply the process of using natural human predispositions to break down defense barriers that are obstacles in the sales process. In this manner, your prospect is a voluntary and willing participant, and becomes happily involved in a buying decision that you have rendered painless and even enjoyable.

One such powerful mind control tactic is the power of no, or denial. If a party believes or perceives that their opportunity to acquire a product is going way and that others are taking advantage of the situation, they may become more likely to move forward with a purchase. In a sense, this is the phenomenon upon which the concept of artificial scarcity is based.

As explained on the Wikipedia website, artificial scarcity describes the scarcity of items even though the technology and production capacity exists to create an abundance of the item. The term is aptly applied to non-rival resources, i.e. those that do not diminish due to one person's use, although there are other resources which could be categorized as artificially scarce. The most common causes of artificial scarcity are monopoly pricing structures, such as those enabled by intellectual property rights or by high-fixed costs in a particular marketplace. In a market economic system, an abundance of a product is not produced because excess product is considered an inefficient use of resources; those resources could be used elsewhere to produce something in greater demand to fulfill more wants. If somehow people desired nothing, there would be no scarcity. If resources were great enough to produce more than anyone desired, there would also be no scarcity. A paradox is reached with artificially scarce products, as abundance is possible, yet without creating scarcity via illegal or subversive means, there is minimal profitability. If scarcity is allowed to reach zero, the economic model fails. If natural scarcity no longer exists, artificial scarcity can be created to ensure functioning of the system.

Artificial scarcity is then a psychological tool that motivates people to purchase based on a perceived inability to purchase in the future. Some of the tools used to create artificial scarcity include the following:

(a) Establishing a price floor or a minimum price. This discourages access to a resource (creating scarcity and profits) and waste is produced.

(b) Establishing a price ceiling or a maximum price. This discourages production while encouraging consumption of a resource (two way creation of scarcity).

(c) Providing subsidies, which may be subsidies to production (usually creating surpluses) or subsidies to consumption (usually creating shortages).

The following example is provided to illustrate how artificial scarcity can operate. Suppose a supplier has an inventory of 900,000 products manufactured. Artificial scarcity is created by the supplier offering only 500,000 of those products and stating that there will be no more available. The establishment of this artificial scarcity can create a demand by setting a demand ceiling at 500,000 products. Subsequently, as sells of the product progress, additional inventory can be released at a higher price and a smaller quantity. Thus, the artificial scarcity in this example is created by controlling or limiting the visible inventory.

Its certainly no secret that brick-and-mortar establishments have lost significant sales revenue to online businesses. A great advantage of online stores is that unlike a chain of stores spread across the country, a single online market place can entertain and support a company's entire market base. Thus, for a store like OLD NAVY to take advantage of the employment of psychological tactics such as artificial scarcity, in some sense they are limited to pool of customers that frequent the store. However, in an online scenario, the entire world shops at the same location, such as AMAZON.COM or EBAY.COM. This is a great advantage for utilization of the psychological sells techniques. This is equally true in an online auctioning environment.

However, the creation and deployment of such techniques, especially artificial scarcity in an online environment requires a technological solution. Thus, there is a need in the art for a technique to deploy psychological sells tactics in an online environment, including the ability to create artificial scarcity in an online auctioning environment.

### BRIEF SUMMARY OF THE INVENTION

An embodiment of the present invention operates within an auctioning system to provide greater flexibility and control over the psychological tactics employed during the auction. Namely, the present invention includes tools that enable an administrator, such as an auctioneer and/or a clerk or others, to control the presentation of items during the auction. Advantageously, the controls obtained through various embodiments of the present invention enable an administrator to more aptly create artificial scarcity and/or establish relative worth of the items being auctioned—as well as employ other psychological tactics.

Another aspect of the present invention is a selling price agnostic credit rating for the bidding participants. In general, each item being auctioned in assigned a credit value. When a party registers for an auction, they are qualified through various means for a particular credit rating which typically will be expressed as a function of credits. Thus, a participant can bid on any time in the auction that has a credit value that is within the number of credits that the participant has. As a participant wins items, the remaining credits of the participant is decreased by the amount of the credit value associated with the won item.

One embodiment of the present invention includes an auctioning system that operates within and supports a live auction. The embodiment includes an administrator interface, a catalog system and a control system interface. The administrator interface allows an auction administrator, such as a clerk, auctioneer or other designated parties, to control the auction and, to manage the sequencing of items through the auction. The catalog system includes information pertaining to the items to be auctioned. The information may include the identification and descriptions of the items to be auctioned, grouping assignments and credit values for each item and each group of items. The control system interface operates to enable one or more items identified in the catalog system to be moved from one group to another group. In addition, the control system may allow the administrator to move items from a non-visible group into a visible group, combine items into a group, remove items from a group, change the description of items or groups of items, change the credit values of an item or group of items, and provide messages to the auctioneer regarding the items and groupings. In addition, during the auction the remaining credit limit for each participant in the audience is maintained. If a participant attempts to bid on an item that has a credit value that exceeds his credit rating, then the bid can be rejected.

These and other aspects, features and embodiments of the present invention are more specifically described in conjunction with the figures and the detailed description that follows.

### BRIEF DESCRIPTION OF THE SEVERAL VIEWS OF THE DRAWING

FIG. 1 is a system level block diagram illustrating an online auctioning system that can support remote bidders as well as live, onsite auction bidders.

FIG. 2 is a system block diagram illustrating how the various aspects of the present invention can be incorporated into the auctioning system.

FIG. 3 is a system block diagram illustrating an exemplary embodiment of the present invention.

FIG. 4 is a conceptual diagram illustrating a potential screen view for an administrator interface.

### DETAILED DESCRIPTION OF THE INVENTION

The present invention, as well as features and aspects thereof, is directed towards providing the ability to employ psychological tactics in an online auctioning environment to increase sells.

Within the auction industry, psychological tactics can be employed to create bidding interest and therefore increase the bidding amounts. One such psychological tactic includes the creation of artificial scarcity. In an auctioning environment, artificial scarcity includes providing limited information to bidders prior to commencing the bidding on an item or group of items and then providing the capability to change the information and make ‘new’ information available to bidders as the auction progresses. The information is managed such that artificial scarcity is perceived by the bidders. In one embodiment of this aspect, the information management includes only offering a limited number of items at the defined terms.

An auction is comprised of a number of items established by the auctioning company. These items may be auctioned individually or can be grouped together and sold in a variety of manners, such as the choice and privilege process. In the choice and privilege process, the winning bidder is able to select one or more of the items in a group or lot and, once the winning bidder has selected the lots they wish to purchase, the runner-up bidder is able to select items they wish to buy at the same price. Once the runner-up bidder is finished, the remaining items within the group can be made available to any buyer at the same price.

If the value received for ‘purchased’ items is less than expected or the items are not generating an interest, the administrator then has the ability to add or remove items from the auction based on the results of the sale of the previous items. Typically, the items are added or removed before the next bidding cycle commences. Once the modifications are done, revised information is presented to all bidders at the beginning of the next bidding cycle. By keeping items in reserve (i.e., not making the items available during the initial bidding cycle(s)) the administrator attempts to increase the bid value with the presentation of a limited number of items of a certain type. If only ‘x’ items are available the buyer assumes a potential scarcity may exist and may be willing to bid higher than first anticipated to ensure than he/she can obtain the item desired. This is artificial scarcity. If the prices received from the sales are higher than expected, additional like items may be added at the ‘last minute’ as new items made available from the “supplier”.

However, if the prices received during the auction are less than desired, the inventory may be removed from the current information set and re-grouped with remaining items to form new ‘groups’ such that a ‘new’ offering may result in a higher value obtained.

A second factor in establishing artificial scarcity is the ability to initially auction an item based on a “reserve value (minimum value at which the item will be sold)” versus “absolute (item will be sold unrestricted for the highest received bid). This information can also be revised, as determined by the administrator, prior to the resumption of bidding on the items.

The sense of artificial scarcity is generally gained by: (1) having a limited number of like items be available for review by the bidders; and (2) having the ability to add or remove items from the bidder's view to reinforce the scarcity (i.e., only three left of this type).

Other psychological techniques can also be employed in an auctioning environment. For instance, the use of “relative worth” can be used to inflate bidding prices as well as sells. For instance, if an auction is putting up some condos for bidding, a lot may include 5 two-bedroom condos and only 1 three-bedroom condo and 1 four-bedroom condo. Although the builder may very well have additional condos available, including 2, 3 and 4 bedroom condos, this is the only inventory visible to the bidding audience. As a result, scarcity may be perceived for the larger condos (three and four bedroom condos). As a result, bidding for the larger condos may be inflated, which in turn will most likely result in inflating the bidding on the two-bedroom condos.

As another tactic, once the bidding for the larger condos has resulted in inflating the price, then additional inventory can be introduced, such as addition additional three and four-bedroom condos to create a perceived scarcity for the smaller units.

Another psychological technique is to modify the packages in a manner that makes them look more attractive or appealing. For instance, several dump trucks with similar operating hours but different years of manufacturing can be lumped together into a lot in which the bidders bit on any one of the items in the group. The winner gets to pick 1, 2 or more of the items in the group. Others can then select the remaining items at the same price. Thus, one item in the group may result in raising the price on the other items in the group. A similar example could be used in real-estate by grouping two-bedroom condos located on a corner of the building with three-bedroom condos that are not located on a corner.

Another example of creating relative worth is provided in the selling of vacation weeks for resorts or other locals. The initial listing can be subsequently edited to add new descriptive material that may be more appealing to the bidding audience. For instance, an inventory item that is not selling because it is at an unattractive time can be lumped with a Christmas week. If that does not work, the item can then include lift tickets. Again, this can be modified to then include a summer week and grocery allotment. Thus, this particular technique, which can be best described as inventory manipulation, helps to adjust or manage perceived value during an auction.

In general, auctioning systems, online auction systems, live-in-the-lane traditional style auctions, cow pasture auctions, as well as other variations and combinations of these variations have a somewhat rigid structure. This is evident in the item in processing and auction set up procedures. Prior to commencing with the auction, items are identified, categorized and either classified as an item to be auctioned off alone, or in a group or lot with other items. Once the auction commences, these definitions are not typically modified. Typically, the more informal an auction setting is, the more tendency there is to be able to combine items, separate items, and through in kickers on the fly. However, when you move into an online auctioning scenario, especially one that combines live bidders with remote bidders, there is less flexibility in an auctioneer's ability to modify lots and offerings on the fly. The present invention provides tools that operate in conjunction with an online auction and provide the flexibility to make such modifications. Advantageously, having such flexibility, as described above, greatly increases the ability to employ psychological tactics in the auctioning process.

To best illustrate the various aspects, embodiments and features of the present invention, the invention will be described in a particular embodiment. This embodiment is the commercially available ONLINE RINGMAN system available from Auction Management Solutions, Inc., located in Tampa Fla. Initially a general description of the ONLINE RINGMAN system is presented. Following this is a description of how various components of the ONLINE RINGMAN system can be modified or enhanced to achieve an embodiment of the present invention. It should be understood that the following example is a non-limiting example and that those skilled in the art will be able to incorporate the various aspects and features of the present invention into a variety of auctioning systems, as well as other similar systems.

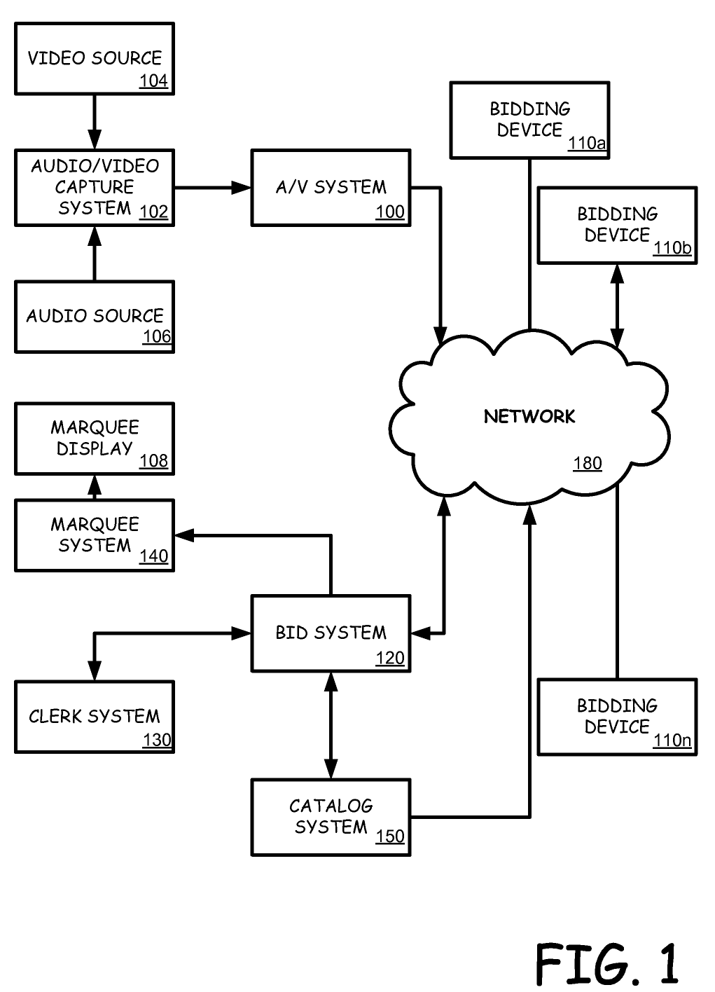

FIG. 1 is a system level block diagram illustrating an online auctioning system that can support remote bidders as well as live, onsite auction bidders. The illustrated auction system includes three main systems, each of which is preferably co-located, to perform the control functions of the auction but, may also be distributed as well. The three main systems include the A/V System 100, the Bid System 120 and the Catalog System 150.

The Bid System 120 operates to control, manage, and/or monitor the interaction among the Bidding Devices 110a-n, a Clerk System 130, and a Marquee System 140.

The Bid System 120 interfaces with the Marquee System 140 and provides information to be rendered onto the Marquee Display 108. The information to be rendered can include a variety of information. A few non-limiting examples of such information includes bidding activity, current high bid, current high bidder, location of current high bidder (floor or remote), current top 5 bidders, bidders engaged in a ping-pong activity, the item being auctioned, the auctioneer, description of item being auction, other information about the item, status of auction, next bid being asked, reserve, reserve flag indicating if an when the reserve is met, seller or consignor, etc.

The Bid System 120 interfaces with the Clerk System 130. The Clerk System 130, which can be manned by a clerk, an auctioneer or the like, receives and controls the sequencing of items through the auction and controls the auction bidding process for each item to be sold. The Bid System 120 and the Clerk System 130 can be incorporated into a single system. As bids enter the Bid System 120, they are communicated to the Clerk System 130 for display to the auctioneer and optionally to the Marquee System 140 for display.

The Catalog System 150 maintains the pre-sales data on items to be sold (this function may alternatively be performed by either the A/V System 100 or the Bid System 120). In the normal auction configuration, the pre-sales catalog information is kept on the Catalog System 150. The Catalog System 150 includes the listing of all items to be sold, identifies the lots or groupings for the items, descriptions of the items, reserves, consignor information, etc. This information or portions of this information can be obtained by the Bidding Devices 110a-n through the network 180 and by the Bid System 120 and the Clerk System 130 via the Bid System 120.

The A/V System 100, operates to capture and provide real-time, or near real-time audio and video of the activity at a live auction to remote bidders. It should be appreciated that in some embodiments of the present invention, a traditional live auction is not included and as such, the A/V System 100 would not be necessary in such an embodiment. The A/V System 100 receives an audio/video stream from the Audio/Video Capture System 102 and then retransmits this stream to each of the Bidder Devices 110a-n through network 180. The Audio/Video Capture System 102 receives video feeds from a video source 104 located on the auction site and an audio source 106 also located at the auction site. For instance, the video source may be one or more video cameras positioned around the auction floor to show the items being auctioned and/or the antics of the auctioneer and the audience. Some embodiments may include audio only, some embodiments may include audio with a series of still shots, and yet other embodiments may include full blown live audio and video delivered in real time with minimum or negligible delay. The A/V Capture System 102, which may consist of specific hardware cards installed in a computer system, encapsulates the audio/video stream. The A/V Capture System 102 interfaces to a Video Source 104 and an Audio Source 106. This data is transmitted to the A/V System 100 where it is re-encapsulated and broadcast to each of the Bidder Devices 110. This function can be performed independent of the Marquee System 140, Clerk System 130 and Bid System 120.

In one implementation, the auction bidding process can be controlled by the Bid System 120 and the Clerk System 130. Data for each item to be sold is extracted from the system maintaining the pre-sales information prior to the auction start, transferred to the Bid System 120, and broadcast to all Bidder Devices 110 and the Marquee System 140 as the items are auctioned. A starting bid is established on the Clerk System 130 and then bids are accepted from floor or remote bidders. Status is transmitted to the Marquee System 140 and the Bidder Devices 110, and logs are maintained identifying activity including status of each bid made by a remote bidder.

In a practical embodiment of the present invention, the A/V System 100, the Clerk System 130, and the Marquee System 140 are assigned to an “area” within the Bid System 120 called an environment. Bidders entering into an auction through a Bidder Device 110 are assigned to that same environment. It should be appreciated that although the various systems and components are presented as separate blocks in the diagram, the systems can be viewed as functional separations rather than physical separations and thus, can be incorporated into a single computing system as modules or can be split up or combined in a variety of configurations.

Additional details of the operation and configuration of the ONLINE RINGMAN system can be obtained by reference to U.S. Pat. No. 6,813,612 which is incorporated into this specification by reference.

The present invention can be incorporated into an ONLINE RINGMAN or similar system by addition additional components to the system. The components can take on various embodiments including software, software embodied on a media that is tangible and readable by a computing device, a separate hardware item, or a combination of these and other embodiments. One embodiment of the invention will be described as being incorporated into an ONLINE RINGMAN system by including a number of modules to perform the various functions of the invention for either single items or grouped items. Thus, once the present invention is incorporated into an environment, such as ONLINE RINGMAN, additional functionality and flexibility for the system is attained. Thus, the present invention includes, but is not limited to an online auctioning system that includes the enhanced features, as well as the features and capabilities themselves.

One module and/or function is termed grouping-on-the-fly. This function allows an administrator, such as an auctioneer, a clerk or a catalog operator to add and remove items from a group or lot that is currently being auctioned. In addition, this function enables the ability to create new groups of items as the auction progresses. When a group is modified, the new item list associated with the group may be presented to the bidders at the beginning of a bidding cycle, at the conclusion of a previous bidding cycle, or even interjected between bids of a current bidding cycle.

In one embodiment of this aspect of the present invention, the administrator is able to utilize a ‘drag and drop’ process to: (a) remove an item from a group to make it a single item; (b) move a single item into a current group to add items to a group; and/or (c) move all items from one group into another group.

Typically, each item available in an auction as an identity number or sequence number. In an exemplary embodiment of the present invention, the items are placed into a lot sequence order (ascending) within a group. A single item is considered to be a lot group of one for purposes of grouping. For example, two single items can be combined to make a “group”. The administrator can invoke this function as often as necessary or desired during the auction to create single and grouped items for auctioning. The administrator is provided this flexibility so that the administrator can create groupings or singles in a manner that he or she believe will foment artificial scarcity given a variety of parameters, which may include elements such as the audience, the items being auctioned, etc. In an exemplary embodiment, the modified grouping is not visible to the bidders until the bidding cycle is initiated that deals with the modified single or multiple lot group. Thus, at the beginning a new cycle, groupings may have been modified in such a manner that the remote and local bidders may perceive scarcity, increase in relative worth, or some other psychological perception. As an example, suppose that the administrator is significantly pleased with the bidding activity for a particular lot of items. For the next bidding cycle, the administrator can release more items and indicate that the consignor has just made additional items available to the auction.

In an exemplary embodiment, to provide the most flexibility in the possible groupings and regrouping functions, each of the items in the auction inventory can initially be placed into single item groups. In addition, a single item groups containing a “dummy” item for each of the possible groupings can be created. Thus, single item groups can be dragged and dropped into other groups with ease. One technique to handle this added number of items that would appear in the inventor is to use lot sequence numbers for sorting the items. Thus, the actual items to be auctioned are placed in the inventory listing with lower lot sequence numbers and the group identifying items are assigned higher lot sequence numbers. When the inventory is displayed, sorted in ascending order based on the lot sequence number, the actual auction items appear first in the list. Similarly, when a group is displayed, the items within the group are automatically sequenced in ascending order using the system assigned lot sequence number. By placing the group identifying items at the end of the inventory the actual lots will automatically appear first in the group list used for bidding. Furthermore, the group identifying items can be further segregated, such as by labeling them as OUT signifying that they are not one of the items in group that are available for purchase.

Another module and/or function is termed “edit inventory”. The edit inventory function allows the data presented for an item to be modified during the auction and then be again made available to bidders. Among other actions, the edit inventory function can enable the administrator to modify reserve prices, starting bids and relative worth. In modifying the reserve prices, the administrator may increase the reserve price in an effort to establish a perceived increase in relative worth and scarcity. In modifying the starting bids or the starting bid level, the administrator may increase the starting bid to establish a perceived increase in worth and scarcity. The relative worth values, which are values to be applied against a bidder's ability to bid on items can also be increased to result in a perceived increase in both relative worth and scarcity.

After the administrator makes changes through the edit inventory function, the edit inventory functions performs a save of the modified data. At this point messages are immediately sent to all of the remote bidders, local bidders, or clients that are logged into the system to update their local versions of the data. Advantageously, this aspect of the present invention enables the revised data to be immediately available for upcoming bidding cycles.

Two additional modules and/or functions are termed the “reload inventory” and “reset bids” functions. Both of these functions force the update of the bidder information to reflect revised grouping information. Thus, after an administrator completes a grouping-on-the-fly function, a reload inventory or reset bids function can be initiated to update the bidders.

Another aspect of the present invention is the employment of an alternate credit limit function. This aspect of the present invention operates to establish the credit limit of a bidder based on data that is not directly associated with the actual bid or purchase value of products won by the bidder. For example, in one embodiment of this aspect of the present invention, a bidder may establish a credit base that allows the bidder to bid on and purchase up to six (6) properties immaterial of the actual bid value. Each item that is being bid on in the auction has an associated alternate value defined in the inventor. For example, a property that is valued at up to $99,000 may have a value of one (1), a property valued at $100,000 to $150,000 may have a value of two (2). This process can be repeated up to a maximum property value being assigned a value of (n).

When a bidder registers for an auction, the bidder obtains a certain credit limit. The credit limit may be based on a variety of parameters, such as a deposit, net worth, cash on hand, etc. The bidders' credit limit is basically a number that identifies how many credits or points the bidder can obtain during the auction. Thus, if a bidder establishes a six (6) credit limit, he or she is able to bid on and potentially win up to six items listed as having a value of 1, three items listed as having a value of 2, and so forth. Thus, as long as a bidder's available credit is equal to or larger than the credit points attributed to an inventory item or group, the bidder is able to participate in the bidding. Each time the bidder wins an item, his or her available credit is reduced by the credit value of the purchased item. Thus, although the credit values for particular inventory items are established based on their perceived value or expected value, the credit values are independent from the actual purchase price. Thus, a property valued at $100,000 may be assigned a credit value of one (1). Regardless of what the property sells for (e.g., $40,000 or $250,000), the reduction to the winning bidder's credit is still one credit value or point.

In an exemplary embodiment of the present invention, this aspect of the invention may be implemented within the Bid System 220, the Clerk System 230 or a combination of both.

Another aspect of the present invention is to enable the administrator to exploit the knowledge of the bidder's credit limit function to create artificial scarcity or relative worth. For instance, if the administrator determines that a large number or percentage of the bidders have only 2 credits available, the administrator can introduce a larger number of 3 credit items into the auction and a limited number of two credit items. Thus, such action may result in creating an artificial scarcity for the two credit items (few items available and many bidders involved).

The above-described functions can be implemented in the auctioning system in a variety of manners. In an exemplary embodiment, multiple clients are involved in the process of modifying groups and information during the auction. Thus, the functions are made available on support type client interfaces in addition to the primary client or clerk system. Advantageously, this configuration enables administrative personnel to be in direct contact with the supplier to determine what modifications are to be performed prior to the next bidding cycle.

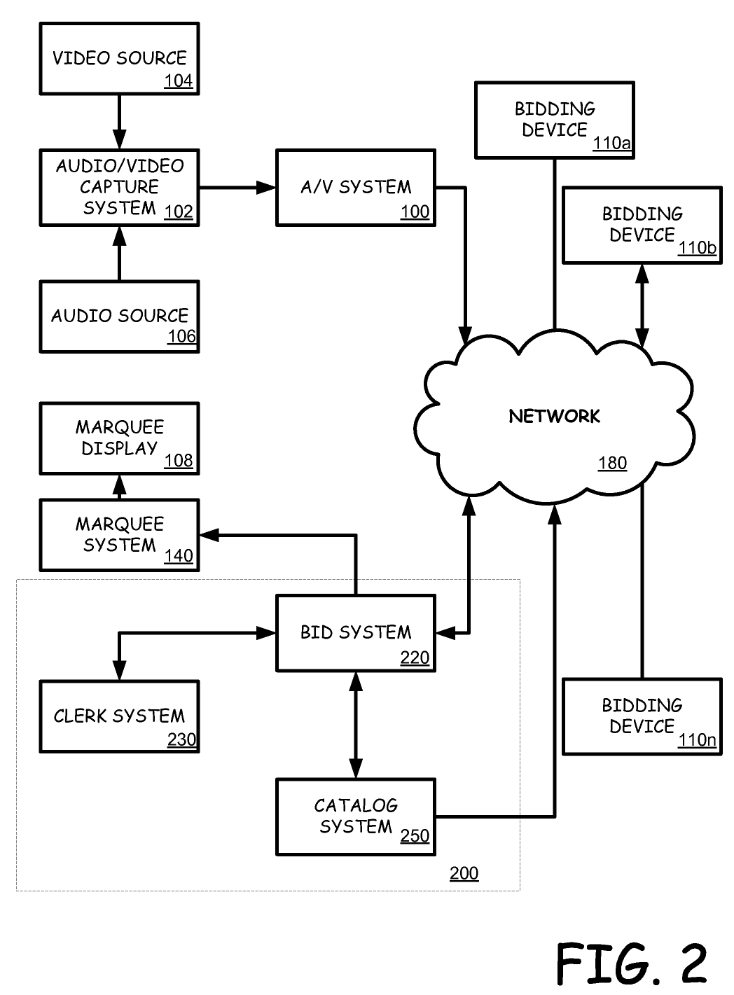

FIG. 2 is a system block diagram illustrating how the various aspects of the present invention can be incorporated into the auctioning system. The enhanced control system components, modules and/or functions 200 may be incorporated into one or more components of the auctioning system. For instance, any, all or a combination of the Bid System 220, the Clerk System 230 and the Catalog System 250 may be modified to incorporate the present invention. For instance, the Clerk System 230 may be augmented to provide the drag and drop interface for the creation of groups while the Catalog System 250 may be modified to create the grouping infrastructure. The Bid System 220 could be modified to enforce the credit limit qualifications on bidders desiring to participate in the auction. In addition, the various aspects and features of the present invention may be implemented in a stand alone manner, either in a separate system or a separate software application that is then invoked by one or more components of the illustrated system or that serves as a front end access to the auctioning system.

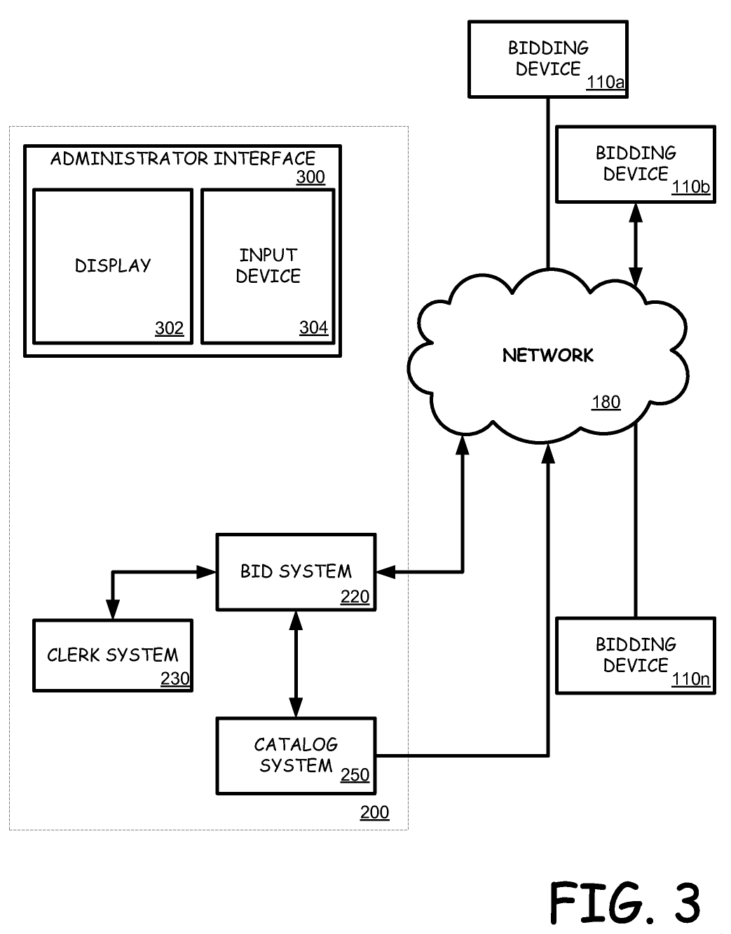

FIG. 3 is a system block diagram illustrating an exemplary embodiment of the present invention. In the illustrated embodiment, an administrator interface 300 is shown as including a display 302 and an input device 304. The administrator interface 300 enables access to each of the various aspects of the present invention including the ability to invoke the various features, and monitor or control various aspects of the features. It should be appreciated that the administrator interface 300 can be included or embodied within the clerk system 230, the clerk system 230 and one or more additional systems, or as a complete stand alone system. It should also be appreciated that the administrator interface 300 may actually include multiple systems providing more than one access point to control the system. In addition, the administrator interface 300 may interface to the auctioning system through the network 180 and thus, may be remote from the auctioning environment. In the latter embodiment, the administrator interface may actually be incorporated into a bidding device and/or may include the audio and video feeds (not illustrated in FIG. 3) from the live auction floor.

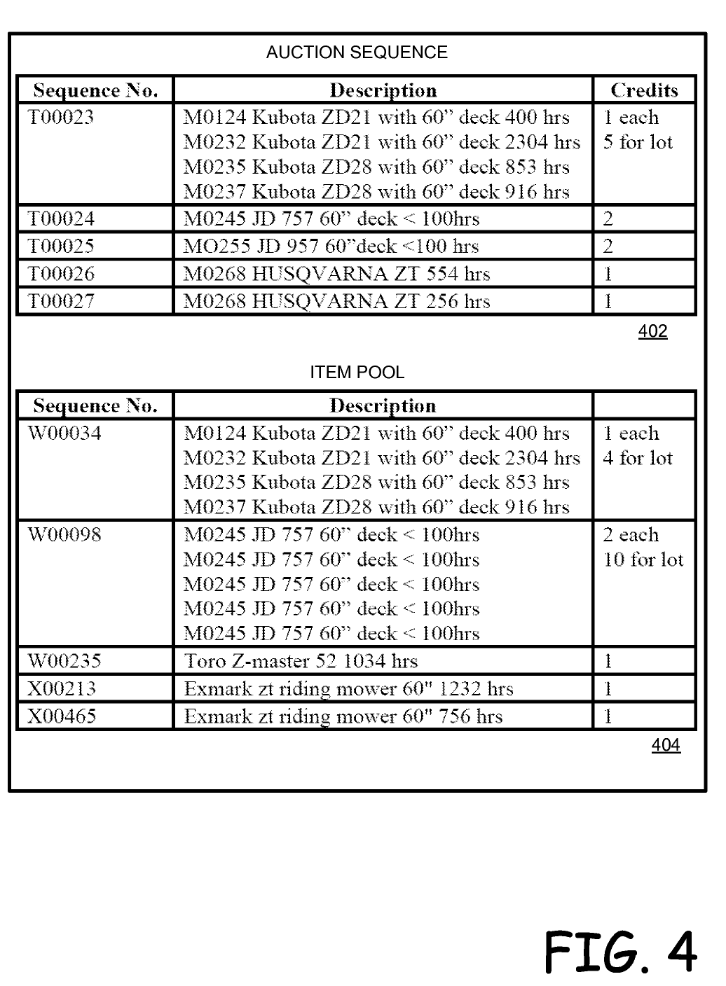

FIG. 4 is a conceptual diagram illustrating a potential screen view for an administrator interface. In the illustrated embodiment, an auction sequence screen 402 shows a list of the next up coming 5 items in the auction. Sequence number T00023 is actually a lot or grouping that includes four mowers of two different types and different specifications. The credit associated with each mower is at a value of 1 and the entire lot is a value of 5. Sequence numbers T00024-T00027 each include only one item with T00024 and T00025 being valued at 2 credits and T00026 and T00027 being valued at 1 credit each. The next item to be auctioned by the auctioning system is T00023.

The illustrated embodiment also includes an item pool screen 404 that includes items that are available to be auctioned. For instance, the item pool screen can be displayed as the result of an administrator conducting a search of the catalog system. For instance, the currently displayed screen may have then the result of a search for zero turn mowers having less than 2500 usage hours. The search may pull up all items in the catalog or, as in the illustrated embodiment, only items that are not currently queued in the auctioning sequence.

The administrator is able to select the items in either the Auction Sequence screen 402 or the Item Pool screen 404 and drag them from one screen to the other. In addition, depending on the embodiment of the invention, the administrator can drag an item from one lot or grouping to another lot or grouping within the same screen or a different screen. Similarly, the administrator can select multiple items and drag multiple items. In another embodiment, the administrator may be able to select multiple items and then actuate a group function to cause the items to be moved into a new grouping by either creating a new group, prompting for and moving them into a selected group, moving them to a default group or moving them to a next dummy grouping available. In addition, each of the items may include hyper links that enable the administrator to select the item and edit the catalog information for that item. Thus, the administrator can select an item and edit the displayed information including the description, the credits associated with the item, as well as any other information for the item. In addition, the groupings may also include a description field that can be selected and/or edited by the administrator to describe various aspects or features of the grouping. In some embodiments of the invention, the administrators may have a mechanism, such as a text messaging capability, to send comments or suggestions to the clerk system and/or the auctioneer to describe the lot or make comments regarding the lot, such as, these are the only 4 items that the consigner has released for sell, etc. Similarly, each item or grouping may include a field for such a comment, and the field may or may not be displayed on the main auctioning screens (i.e., of the bidding devices and/or the marquee).

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. An auctioning system for supporting a live auction, the system comprising:
an administrator interface that allows an auction administrator to control the auction and, to manage the sequencing of items through the auction;
a catalog system that includes the identification and descriptions of the items to be auctioned; and
a control system interface enabling one or more items identified in the catalog system to be combined into a single grouping and further, to include the single grouping in the sequencing of items through the auction.

2. The auctioning system of claim 1, wherein items identified in the catalog reside in either a visible state or a non-visible state, and wherein the control system interface allows a particular item in the non-visible state to be moved into a grouping with items in a visible state, thereby making the particular item visible.

3. The auctioning system of claim 1, wherein the control system interface enables the single grouping to be made visible or non-visible.

4. The auctioning system of claim 1, wherein the control system interface enables a description of the single grouping to be created and edited.

5. The auctioning system of claim 1, wherein the control system interface enables a description of an item identified in the catalog system to be modified.

6. An auctioning system for supporting a live auction, the system comprising:
an administrator interface that allows an auction administrator to control the auction and, to manage the sequencing of items through the auction;
a catalog system that includes the identification and descriptions of the items to be auctioned, each item identified in the catalog system being assigned to a grouping; and
a control system interface enabling one or more items identified in the catalog system to be moved from a first grouping into a second grouping and further, to include at least one of the first or second groupings in the sequencing of items through the auction.

7. The auctioning system of claim 6, wherein the control system interface further comprises one or more placeholder groupings capable of receiving items and being included in the sequencing of items, and the second grouping being one of the placeholder groupings.

8. The auctioning system of claim 7, wherein the first grouping is not visible and the second grouping is visible to an auctioning audience.

9. The auctioning system of claim 8, wherein the control system interface further enables a description of the second grouping to be created and modified.

10. The auctioning system of claim 7, wherein the control system interface enables items in the first grouping and the second grouping to be displayed to the administrator and further enables the administrator to move items from the first grouping to the second grouping, while the auction is live.

11. The auctioning system of claim 7, wherein the control system interface enables items in the first grouping and the second grouping to be displayed to the administrator and further enables the administrator to move items from the first grouping to the second grouping, while the auction is live by dragging and dropping the items.

12. The auctioning system of claim 7, wherein each item in the catalog system is assigned a sequencing number and each grouping is assigned a sequencing number and wherein groupings that are not-visible to the auctioning audience are assigned large sequencing numbers.

13. The auctioning system of claim 7, wherein each item in the catalog system and each grouping includes a credit value wherein the credit value is independent of the actual selling price of the item or grouping of items, and each participant in the auction audience has a credit limit identified as a number of credits that can be purchased, and the auctioning system is further operable to keep track of the credit limit, the items won and a remaining available credit for each participant in the auctioning audience.

14. The auctioning system of claim 13, wherein the control system enables an administrator to identify the remaining credit for participants in the auction and to select and move items and groupings identified in the catalog based on the credit value of those items and groupings.

15. The auctioning system of claim 14, further comprising a bidding device interface over which the auctioning system can receive bids from remote bidders and providing bidding status information to the remote bidders.

16. The auctioning system of claim 15, wherein if the credit value for an item or grouping that is currently being auctioned exceeds the remaining available credit for a remote participant, then bids submitted by the remote participant are not accepted.

17. An auctioning system for supporting a live auction, the system comprising:
an administrator interface that allows an auction administrator to control the auction and, to manage the sequencing of items through the auction;
a catalog system that includes the identification and descriptions of the items to be auctioned, each item identified in the catalog system being assigned to a grouping and each item and each grouping having a credit value that is independent of the actual selling price of the item or grouping;
a control system interface enabling:
one or more items identified in the catalog system to be moved from a first grouping into a second grouping and further, to include at least one of the first or second groupings in the sequencing of items through the auction,
a remaining credit limit for each participant in the audience to be maintained, the remaining credit limit identifying the number of credits available for the participant, and
the selecting and moving of items and groupings identified in the catalog based on the credit value of those items and groupings.

18. The auctioning system of claim 17, further comprising:
a remote bidding device interface enabling bids to be received from remote bidding participants; and
if the credit value for an item or grouping that is currently being auctioned exceeds the remaining available credit for a remote participant, then bids submitted by the remote participant are not accepted.

19. The auctioning system of claim 18, wherein the first grouping is not visible and the second grouping is visible to an auctioning audience.

20. The auctioning system of claim 19, wherein the control system interface enables items in the first grouping and the second grouping to be displayed to the administrator and further enables the administrator to move items from the first grouping to the second grouping, while the auction is live by dragging and dropping the items.
